(19) United States
(12) Patent Application Publication
(10) Pub. No.: US 2015/0329095 A1
(43) Pub. Date: Nov. 19, 2015

(54) METHOD FOR ESTIMATING THE PRESSURE IN A VACUUM RESERVOIR OF A BRAKE SERVO

(71) Applicant: RENAULT S.A.S., Boulogne-Billancourt (FR)

(72) Inventors: Hamid AZZI, Maurepas (FR); Regis SANCHEZ, Rambouillet (FR)

(73) Assignee: RENAULT S.A.S., Boulogne-Billancourt (FR)

(21) Appl. No.: 14/647,496

(22) PCT Filed: Oct. 21, 2013
(86) PCT No.: PCT/EP2013/071978

§ 371 Date: Aug. 6, 2015

(30) Foreign Application Priority Data
Nov. 29, 2012 (FR) 1261381

(51) Int. Cl. B60T 17/22; G01M 3/26; B60T 13/52

(52) U.S. Cl. CPC B60T 17/22; B60T 13/52; G01M 3/26

(57) ABSTRACT

A method for estimating pressure in a vacuum reservoir of a vacuum brake servo of a motor vehicle, the vehicle including: a braking device operated by pressure of a brake fluid; a brake servo amplifying force of an actuating member using a vacuum supplied by a reservoir; a pressure sensor configured to measure the braking pressure of the brake fluid; the method includes: calculating the braking pressure; calculating amplitude of a reduction in braking pressure; estimating increase of the pressure in the vacuum reservoir as a function of the amplitude.

The invention relates to a method for estimating the pressure in a vacuum chamber for a vacuum brake servo of a motor vehicle.

The invention more particularly relates to a method for estimating the pressure in a vacuum chamber of a vacuum brake servo of a motor vehicle, the vehicle comprising:
an internal combustion engine;
at least one braking device controlled by the pressure of a brake fluid;
a master cylinder, which controls the pressure of the brake fluid and which is actuated by an actuating member movable between a rest position and an end actuation position;
a brake servo, which is arranged between the actuating member and the master cylinder to amplify the force of the actuating member, by means of a vacuum provided by a chamber held under vacuum, to an assistance pressure when the engine is started;
a means for detecting the displacement of the actuating member beyond an intermediate guard position;
a pressure sensor, which is designed to measure the braking pressure of the brake fluid.

Motor vehicles are generally equipped with braking devices, such as disk brakes, which are controlled by the pressure of a brake fluid. The pressure of the brake fluid is more particularly controlled by a master cylinder, which is actuated by the driver via an actuating member commonly formed by a brake pedal.

The pressure required for the braking devices to function effectively is very high. In order to assist the braking effort of the driver, it is known to equip the vehicle with a vacuum brake servo, also referred to as a brake booster or master vac. For this purpose the brake servo uses a vacuum produced when the engine is started. The vacuum is produced for example by a vacuum pump driven by the engine, or is produced directly by the operation of the engine, at an air intake circuit.

In addition, in order to reduce pollution and save fuel, it is known to equip vehicles having a combustion engine with a system for automatic stopping and starting, better known as a start and stop system. Such a system makes it possible to automatically stop the combustion engine when the vehicle is stopped for a short period, for example at a red light or in traffic jams. The engine is restarted automatically when the driver performs a maneuver to restart the vehicle, for example by pressing on the acceleration pedal or by engaging a gear.

Nevertheless, such a device has the disadvantage of interrupting the vacuum production by the engine although the vehicle is still in a driving situation. Thus, if the driver pumps the brake pedal during an automatic stopping of the engine, the vacuum in the brake servo is no longer sufficient for the master cylinder to be effectively actuated.

In order to overcome this problem it is known to arrange a vacuum chamber between the vacuum source and the brake servo. This chamber thus allows the driver to benefit from a vacuum reserve sufficient to actuate the master cylinder a number of times.

Nevertheless, this solution is not suitable for all situations.

It has thus been proposed to automatically restart the combustion engine when the pressure in the vacuum chamber becomes greater than a determined maximum threshold. To do this, it is known to directly measure the pressure in the vacuum chamber by means of a pressure sensor.

However, although this solution is satisfactory from a technical viewpoint, it is not economically advantageous, since it requires the installation of a pressure sensor dedicated to the vacuum chamber.

The invention proposes to overcome this problem by estimating the pressure present in the vacuum chamber by means of sensors already present in the vehicle. The invention thus proposes a method of the type described previously, characterized in that it comprises:
a first step of calculating the braking pressure, which is repeated cyclically;
a second step of calculating the amplitude of a reduction in pressure, during which the maximum then the minimum reached successively by the braking pressure are stored, and during which the amplitude of the reduction in braking pressure is calculated by establishing the difference between the maximum and the minimum;
a third step, which is triggered at the end of the second step and during which the increase in the pressure in the vacuum chamber is estimated as a function of the amplitude calculated in the second step.

In accordance with further features of the invention:
during the first step, the braking pressure calculated is equal to:
   a rest value as long as no displacement of the actuating member is detected; or to
   the greater value between the measurement of the braking pressure by the sensor and a minimal pressure determined when a displacement of the actuating member is detected;
the third step is triggered when the engine is stopped;
the method comprises a fourth step of requesting a restart, during which the engine is restarted when the pressure in the chamber is greater than a determined threshold;
during the third step the increase in pressure in the chamber is estimated as a function of the amplitude of the reduction in pressure on the basis of a predetermined correspondence curve;
the predetermined curve has a stepped form so as to match a determined increase in the pressure to a determined range of values of the amplitude of a reduction in braking pressure;
when the engine is restarted, the pressure in the chamber is reset to a minimum value;
during the second step, a first pressure value is considered as a pressure maximum when a second pressure value calculated in the cycle following the first step is strictly lower than the first value;
during the second step, a first pressure value is considered as a minimum when:
   a maximum was reached beforehand;
   and a second pressure value calculated in the cycle following the first step is greater than or equal to the first pressure value;
the second step is repeated when a minimum has been reached.

Further features and advantages of the invention will become clear upon reading the detailed description provided below, which will be understood with reference to the accompanying drawings, in which:

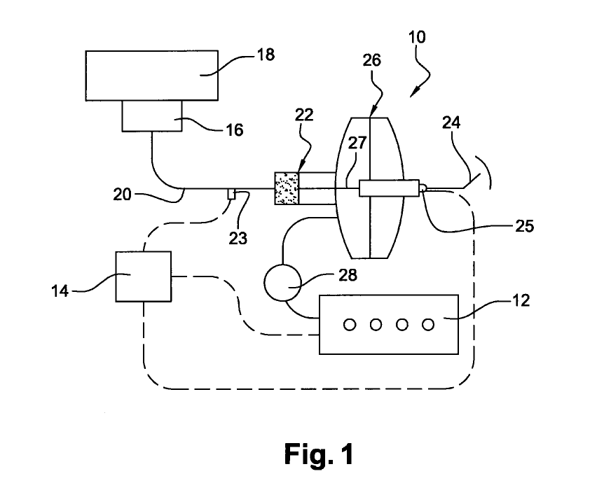

FIG. 1 is a diagram showing a motor vehicle having a combustion engine equipped with a braking device comprising a vacuum brake servo;

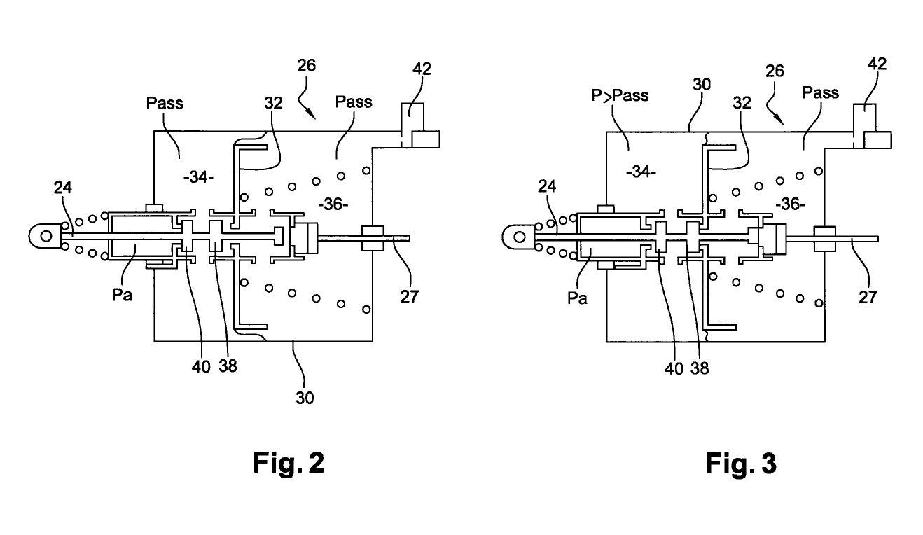

FIG. 2 is a sectional view showing the vacuum brake servo of FIG. 1 in a rest state;

FIG. 3 is a view similar to that of FIG. 2 in which the brake servo is in an actuated state;

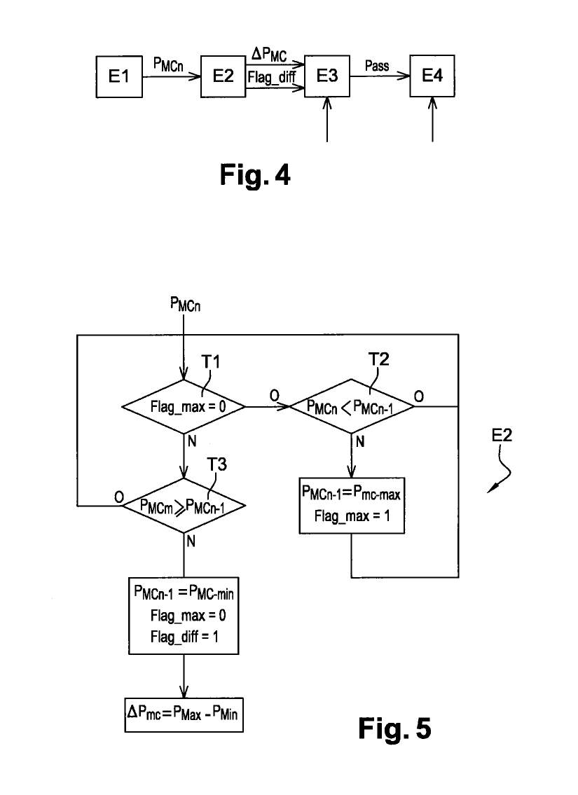

FIG. 4 is a block diagram showing a method for estimating the pressure in a vacuum chamber of the brake servo formed in accordance with the teaching of the invention;

FIG. 5 is a block diagram showing in greater detail the second step of the method of FIG. 4;

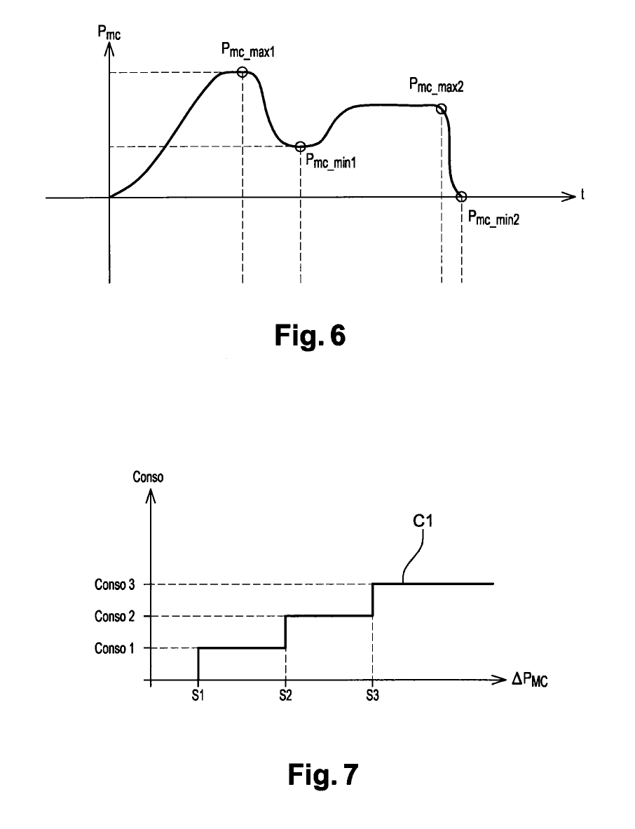

FIG. 6 is a graph showing the variation in brake fluid pressure over time;

FIG. 7 is a graph showing the estimated increase in assistance pressure in the chamber as a function of the amplitude of the reduction in braking pressure.

In the description below, elements having an identical structure or similar functions will be denoted by the same reference number.

FIG. 1 schematically shows a motor vehicle 10 moved by a combustion engine 12. The combustion engine 12 is able to be stopped and restarted automatically by an electronic control unit 14.

The vehicle 10 also comprises braking means of the vehicle. The braking means here comprise a number of braking devices 16, each of which is associated with a wheel 18 of the vehicle 10. To simplify the drawings only one wheel 18 and the associated braking device 16 have been shown.

The braking device 16 is formed for example by a disk brake that comprises brake pads (not shown), which are carried by a fixed caliper and which can be displaced between a rest position in which they are distanced from the disk and a position in which they clamp a brake disk (not shown) so as to be rotated with the wheel 18.

The braking device 16 is controlled between its rest position and its clamping position by the pressure “Pmc” of a brake fluid contained in a hydraulic circuit 20. As is known, the brake fluid in this case is an incompressible liquid.

The pressure “Pmc” of the brake fluid is controlled by a master cylinder 22. In a simplified manner, the master cylinder 22 acts as a piston that is able to be displaced between a rest position and a position of compression of the brake fluid contained in the hydraulic circuit 20.

As a safety measure, the hydraulic circuit 20 has a pressure sensor 23, which is designed to measure the pressure “Pmc” of the brake fluid at any time. This pressure will be referred to hereinafter as the “braking pressure Pmc”. The sensor 23 sends a signal representative of the braking pressure “Pmc” to the electronic control unit 14.

A push rod 27 of the piston of the master cylinder 22 can be pushed by the driver of the vehicle 10 by means of an actuating member 24. The actuating member 24 in this case is a brake pedal, which is movable between a rest position, into which it is resiliently returned, and an end actuation position, in which the pressure “Pmc” of the brake fluid rises in order to actuate the braking device 16 into the braking position thereof.

However, the braking pressure “Pmc” requires a very high force on the push rod 27 of the master cylinder 22 in order for the braking device 16 to effectively brake the vehicle 10.

Also, to assist the driver, it is known to arrange a vacuum brake servo 26 between the actuating member 24 and the master cylinder 22 in order to amplify the force of the actuating member 24 by means of a vacuum provided by a chamber 28 held under vacuum when the engine 12 is started. The pressure in the chamber 28 is then equal to a minimum assistance pressure “Pass_min”.

The operating principle of the vacuum brake servo 26 is explained in greater detail in FIGS. 2 and 3.

The brake servo 26 comprises a rigid housing 30 divided by a flexible partition 32 into a rear chamber 34 and a front chamber 36. The partition 32 is able to urge the push rod 27 of the master cylinder 22 into its position of compression of the brake fluid. The partition 32 also has two valves 38, 40, which are controlled by the actuating member 24.

The two chambers 34, 36 are able to communicate with one another by means of a first valve 38, which is controlled by the actuating member 24.

The rear chamber 34 is able to communicate with the atmospheric pressure “Patm” by means of a second valve 40, which is also controlled by the actuating member 24.

The front chamber 36 can be supplied with a first pressure “Pass”, referred to as an assistance pressure, which is lower than the atmospheric pressure “Patm”, by means of an orifice 42 communicating with the vacuum chamber 28.

When the actuating member 24 is in its rest position, as shown in FIG. 2, the two chambers 34, 36 communicate with one another by means of the first valve 38 whilst the second valve 40 is closed.

When the braking element 24 is actuated, the first valve 38 is closed, thus isolating the two chambers 34, 36. The second valve 40 is open, thus allowing the air at atmospheric pressure “Patm” to infiltrate the rear chamber 34. The pressure difference “Patm−Pass” between the two chambers 34, 36 causes a displacement of the partition 32, and thus of the push rod 27 of the master cylinder 22, in a forward direction until the second valve 40 is closed, the first valve 38 remaining closed. The amount of atmospheric air introduced into the rear chamber 34 is all the greater, the deeper the actuating member 24 is driven in. In other words, the braking pressure “Pmc” increases to a greater extent, the greater is the volume of air at atmospheric pressure “Patm” introduced into the rear chamber 34 of the brake servo 26.

When the driver releases the actuating member 24, the first valve 38 opens, whereas the second valve 40 remains closed. This leads to a re-balancing of pressure between the two chambers 34, 36, and an expulsion of the air at atmospheric pressure toward the vacuum chamber 28.

Thus, as explained before, during a stopping of the engine, the assistance pressure “Pass” in the vacuum chamber 28 increases solely when the actuating member returns into its rest position, i.e. when the braking pressure “Pmc” decreases.

In addition, as shown in FIG. 1, the actuating member 24 can trigger a detection means 25 when displaced from its rest position beyond an intermediate guard position. The detection means 25 is formed for example by a contactor or a switch.

The displacement of the actuating member 24 between the rest position and the intermediate guard position does not open the second valve 40 in the brake servo 26. This is a “neutral” displacement.

Beyond the guard position, the contactor 25 is triggered. This contactor 25 triggers, inter alia, the lighting of the brake lights of the vehicle 10. Beyond the guard position, the second valve 40 is open so as to drive a displacement of the push rod 27 of the master cylinder 22. However, at the start of this displacement, the braking pressure “Pmc” does not increase substantially for the sensor 23. In fact, at rest, the brake pads are distanced from the brake disk with a play allowing the rotation of the disk without friction. The start of the displacement of the piston corresponds to the displacement of the pads until the disk is contacted. Such a displacement does not require a significant increase in braking pressure “Pmc”.

On this basis, the invention proposes a method for estimating the assistance pressure “Pass” in the vacuum chamber 28 when the engine is stopped. This method is described with reference to FIGS. 4 and 5.

The method comprises a first step “E1” of calculating the braking pressure “Pmc”. This step “E1” is repeated cyclically by the electronic control unit 14 at an increased frequency.

At a determined moment “t”, the braking pressure “Pmcₙ” is equal to a minimum rest value “V0” determined when the contactor 25 does not detect any displacement of the actuating member 24. Otherwise, when the contactor 25 detects a displacement of the actuating member 24, the braking pressure “Pmcₙ” is equal to the greater value between the pressure measurement by the sensor “Vmes” and a determined guard pressure “V1”.

The minimum rest pressure “V0” corresponds to the pressure of the braking fluid when the pads are in their rest position.

The guard pressure “V1” corresponds to the pressure necessary to displace the pads until the disk is contacted. Since this pressure “V1” cannot be detected or can hardly be detected by the sensor 23, this pressure is stored directly in the electronic control unit 14. Thus, in place of being measured by the sensor 23, it is attributed by the electronic control unit 14 when the contactor 25 is triggered.

In the following cycle “t+1”, the electronic control unit 24 calculates the new value of the braking pressure “Pmcₙ₊₁”.

Advantageously, the chronological sequence of the values of the braking pressure “Pmc” forms a braking pressure signal that can be filtered by a filter of the first order (not shown).

During a second step “E2” of calculation of a reduction in pressure, the electronic control unit 14 calculates the amplitude “ΔPmc” of the reduction in braking pressure during a drop in this pressure.

The second step “E2” is shown in greater detail in FIG. 5. During this step “E2”, the maximum “Pmc_max” then the minimum “Pmc_min” reached successively by the braking pressure “Pmc” are stored by the electronic control unit 14.

To do this, as shown in FIG. 5, the test “T1” makes it possible to check that no maximum “Pmc_max” has already been found. This is the case when a first Boolean variable “Flag_max” is equal to zero.

In this case the test “T2” makes it possible to check that the braking pressure “Pmcₙ” calculated in a current cycle “t” is strictly lower than the braking pressure “Pmcₙ₋₁” calculated in the previous cycle “t−1”.

If this is not the case the braking pressure “Pmc” continues to increase or at least plateaus. The maximum “Pmc_max” therefore is not considered as reached. Step “E2” is then repeated.

If this is the case this means that the braking pressure “Pmc” starts to drop. The value of the previous braking pressure “Pmcₙ₋₁” is considered as being the maximum “Pmc_max” and is stored in the electronic control unit 14. The value of the first Boolean variable “Flag_max” becomes equal to one. An example of detection of two maxima “Pmc_max1” and “Pmc_max2” is illustrated in FIG. 6.

Step “E2” is repeated again, but, due to the change in value of the first Boolean variable “Flag_max”, it is now tested in the test “T3” that the braking pressure “Pmc” reaches its minimum. To do this, with each repetition of the second step “E2”, it is checked that the braking pressure “Pmcₙ” calculated in the current cycle “t” is greater than or equal to the braking pressure “Pmcₙ₋₁” calculated in the previous cycle “t−1”.

If this is not the case the braking pressure “Pmc” continues to drop. The minimum “Pmc_min” therefore has not been reached. The step “E2” is then repeated.

If this is the case this means that the braking pressure “Pmc” starts to increase again or at least to plateau. The value of the previous braking pressure “Pmcₙ₋₁” is considered as being the minimum “Pmc_min”.

The latter is stored in the electronic control unit 14. The value of the Boolean variable “Flag max” becomes equal again to zero. An example of detection of two minima “Pmc_min1” and “Pmc_min2” is shown in FIG. 6.

The amplitude “ΔPmc” of the drop in braking pressure is then calculated by the electronic unit 14 by establishing the difference between the stored maximum “Pmc_max” and the stored minimum “Pmc_min”. In order to signal that this reduction is calculated, a second Boolean variable “Flag_diff” becomes equal to one.

A third step “E3” of estimation is triggered at the end of the second step “E2”, when the second Boolean variable “Flag_diff” is equal to one.

During this third step “E3”, the increase “Conso” in the assistance pressure “Pass” in the vacuum chamber 28 is estimated as a function of the amplitude “ΔPmc” calculated in the second step “E2”.

The increase “Conso” in assistance pressure “Pass” is first estimated as a function of the amplitude “ΔPmc” on the basis of a predetermined correspondence curve “C1”. The correspondence curve “C1” is predetermined, for example experimentally, and is recorded in a permanent memory of the electronic control unit 14.

In the example shown in FIG. 7, the predetermined curve “C1” is in stepped form so as to match a determined increase “Conso” in the assistance pressure “Pass” to a determined range of the amplitude “ΔPmc”. Thus, when the amplitude “ΔPmc” is lower than a first threshold “S1”, the increase in assistance pressure “Pass” is equal to a first value “Conso_{—}1”. When the amplitude “ΔPmc” is between the first threshold “S1” and an upper second threshold “S2”, the increase in the assistance pressure “Pass” is equal to a second value “Conso_{—}2” greater than the first, and so on.

At the end of a determined time period, the second Boolean variable “Flag_diff”, the value of the amplitude “ΔPmc”, and the maximum braking pressure “Pmc_max” and minimum braking pressure “Pmc_min” become equal again to zero. The second step “E2” of the method is then repeated.

When the engine 12 is restarted, the assistance pressure “Pass” estimated in the chamber 28 is restarted at the predetermined minimum value thereof “Pass_min”, for example experimentally.

In order to avoid useless calculations, the triggering of the second and/or of the third step “E2, E3” may be dependent on the fact that the engine 12 is stopped automatically by the electronic control unit 14.

The method also includes a fourth step “E4” of restarting, during which the engine 12 is restarted when the estimated assistance pressure “Pass” of the chamber 28 becomes greater than a determined threshold “Pass_max”, beyond which the brake servo 26 is considered as no longer being able to produce a force sufficient to assure the effective braking of the vehicle.

Of course, this fourth step “E4” is also dependent on the fact that the engine 12 has been stopped automatically by the electronic control unit 14.

The method embodied in accordance with the teaching of the invention thus makes it possible to precisely estimate the assistance pressure of the vacuum chamber when the engine is stopped automatically. The estimation is performed economically by using the sensor for measuring the pressure of the brake fluid already used to control the braking of the vehicle, and by using a means for detecting the displacement of the actuating member, this means already being used to light up the brake lights of the vehicle.

The estimation method implemented by the electronic control unit allows a quick and precise estimation of the assistance pressure in the vacuum chamber.

1-10. (canceled)

11. A method for estimating pressure in a vacuum chamber of a vacuum brake servo of a motor vehicle, the vehicle including:
an internal combustion engine;
at least one braking device controlled by pressure of a brake fluid;
a master cylinder, which controls the pressure of the brake fluid and which is actuated by an actuating member movable between a rest position and an end actuation position;
a brake servo, which is arranged between the actuating member and the master cylinder to amplify force of the actuating member by a vacuum, provided by a chamber held under vacuum, to an assistance pressure when the engine is started;
a means for detecting displacement of the actuating member beyond an intermediate guard position;
a pressure sensor configured to measure the braking pressure of the brake fluid;
wherein the method comprising:
calculating the braking pressure, which is repeated cyclically;
calculating amplitude of a reduction in pressure, during which the maximum and then the minimum reached successively by the braking pressure are stored, and during which the amplitude of the reduction in braking pressure is calculated by establishing the difference between the maximum and the minimum;
estimating, triggered at an end of the calculating the amplitude, increase of the pressure in the vacuum chamber as a function of the amplitude calculated in the calculating the amplitude.

12. The method as claimed in claim 11, wherein, during the calculating the braking pressure, the braking pressure calculated is equal to:
a rest value as long as no displacement of the actuating member is detected; or to
the greater value between the measurement of the pressure by the sensor and a minimum pressure determined when a displacement of the actuating member is detected.

13. The method as claimed in claim 12, wherein the estimating is triggered when the engine is stopped.

14. The method as claimed in claim 13, further comprising a restarting, during which the engine is restarted when the pressure in the chamber is greater than a determined threshold.

15. The method as claimed in claim 11, wherein, during the estimating, the increase of pressure in the chamber is estimated as a function of the amplitude of the reduction in pressure on the basis of a predetermined correspondence curve.

16. The method as claimed in claim 15, wherein the predetermined curve has a stepped form to match a determined increase in pressure to a determined range of values of the amplitude of reduction in braking pressure.

17. The method as claimed in claim 14, wherein, when the engine is restarted, the pressure in the chamber is reset to a minimum value.

18. The method as claimed in claim 11, wherein, during the calculating the amplitude, a first pressure value is considered as a pressure maximum when a second pressure value calculated in the cycle following the calculating the braking pressure is strictly lower than the first value.

19. The method as claimed in claim 11, wherein, during the calculating the amplitude, a first pressure value is considered as a minimum when:
a maximum was reached beforehand;
and a second pressure value calculated in the cycle following the calculating the braking pressure is greater than or equal to the first pressure value.

20. The method as claimed in claim 11, wherein the calculating the amplitude is repeated when a minimum has been reached.
